(19) United States
(12) Patent Application Publication
(10) Pub. No.: US 2017/0349398 A1
(43) Pub. Date: Dec. 7, 2017

(54) ELEVATOR SYSTEM AND METHOD FOR MONITORING AN ELEVATOR SYSTEM

(71) Applicant: Otis Elevator Company, Farmington, CT (US)

(72) Inventor: Mustapha Toutaoui, Berlin (DE)

(21) Appl. No.: 15/534,834

(22) PCT Filed: Dec. 11, 2014
(86) PCT No.: PCT/EP2014/077357

§ 371 Date: Jun. 9, 2017

(51) Int. Cl. B66B 1/34; G06Q 10/00; B66B 3/00; B66B 1/28; B66B 5/00; G06Q 30/06; B66B 5/02

(52) U.S. Cl. CPC B66B 1/3461; G06Q 30/0601; G06Q 10/20; B66B 5/02; B66B 1/28; B66B 5/0025; B66B 5/0018; B66B 3/002; B66B 5/0031

(57) ABSTRACT

An elevator system (34) comprises a plurality of elevators (1) each of the elevators (1) comprising: a diagnostic unit (17) which is configured for running at least one diagnostic routine checking components of the elevator (1) and providing elevator operation and diagnosis data; a communication unit (30), which is configured for transmitting the elevator operation and diagnosis data provided by the diagnostic unit (17) to a remote diagnostic system (40); and for receiving control commands from said remote diagnostic system (40); and a control unit (14), which is configured for executing the control commands received by the communication unit (30). The elevator system (34) further comprises a diagnostic system (40) comprising at least one data receiving unit (42), which is configured for receiving the elevator operation and diagnosis data transmitted from the communication unit (30); at least one storage unit (44), which is configured for storing elevator operation and diagnosis data; at least one analyzing unit (46), which is configured for automatically analyzing the elevator operation and diagnosis data received by the at least one receiving unit (42) in order to detect a malfunction of an elevator (1); and at least one instruction unit (48), which is configured for sending instructions to the communication unit (30) of an elevator (1), for which a malfunction has been detected, instructing the control unit (14) of said elevator (1) to perform at least one specific action in order to overcome a detected malfunction.

So called “smart” elevators provide a list of occurred failures in case of disturbances or blockage. In order to put the elevator back into proper operation, an expert has to go through the subsystems (including operation, drive and door) to identify the reason for the detected malfunction and perform the appropriate action. In order to ensure a quick reaction and remedy of malfunctions all over the world, a large number of experts need to be available 24 hours a day at 7 days of the week.

It therefore would be beneficial to provide a system and a method for monitoring elevators, which allows to remedy elevator malfunctions within a short period of time without a large number of experts being present or in standby all the time.

According to an exemplary embodiment of the invention, an elevator system comprises:
A plurality of elevators, wherein each of the elevators includes:
   a diagnostic unit which is configured for running at least one diagnostic routine checking components of the elevator and providing elevator operation and diagnosis data;
   a communication unit, which is configured
      for transmitting the elevator operation and diagnosis data provided by the diagnostic unit to a remote diagnostic system; and
      for receiving control commands from said remote diagnostic system; and
   a control unit, which is configured for executing the control commands received by the communication unit.

The elevator system further includes remote diagnostic system comprising:
at least one data receiving unit, which is configured for receiving the elevator operation and diagnosis data transmitted from the communication unit;
at least one storage unit, which is configured for storing elevator operation and diagnosis data;
least one analyzing unit, which is configured for automatically analyzing the elevator operation and diagnosis data received by the at least one receiving unit by comparing the received data with previously stored data in order to detect a malfunction of an elevator; and
at least one instruction unit, which is configured for sending instructions to the communication unit of an elevator, for which a malfunction has been detected, instructing the control unit of said elevator to perform at least one specific action, which is based on the stored information in order to overcome a detected malfunction.

According to an embodiment of the invention, a method of monitoring an elevator system comprising a plurality of elevators includes the steps of:
a) running at least one diagnostic routine on an individual elevator of the elevator system for checking components of the elevator and providing elevator operation and diagnosis data;
b) transmitting the elevator operation and diagnosis data provided by the diagnostic unit to a remote diagnostic system;

c) storing elevator operation and diagnosis data;

d) automatically analyzing the elevator operation and diagnosis data for detecting a malfunction of an elevator;

e) sending instructions to said individual elevator, for which a malfunction has been detected, instructing said elevator to perform a specific action, which preferably is based on the stored information, in order to overcome a detected malfunction and/or sending informing about a detected malfunction to a mechanic.

Exemplary embodiments of the invention provide an autonomous system using the experts' knowledge and interacting directly with smart elevators. Such a diagnostic system in particular may be implemented as a cloud service in the internet, providing a “Cyber Physical System” (CPS) and an “Internet of Services” (IoS) distributed over a plurality of computers allowing fast access from all over the world and providing redundancy in the case of failure which ensures a high reliability of service.

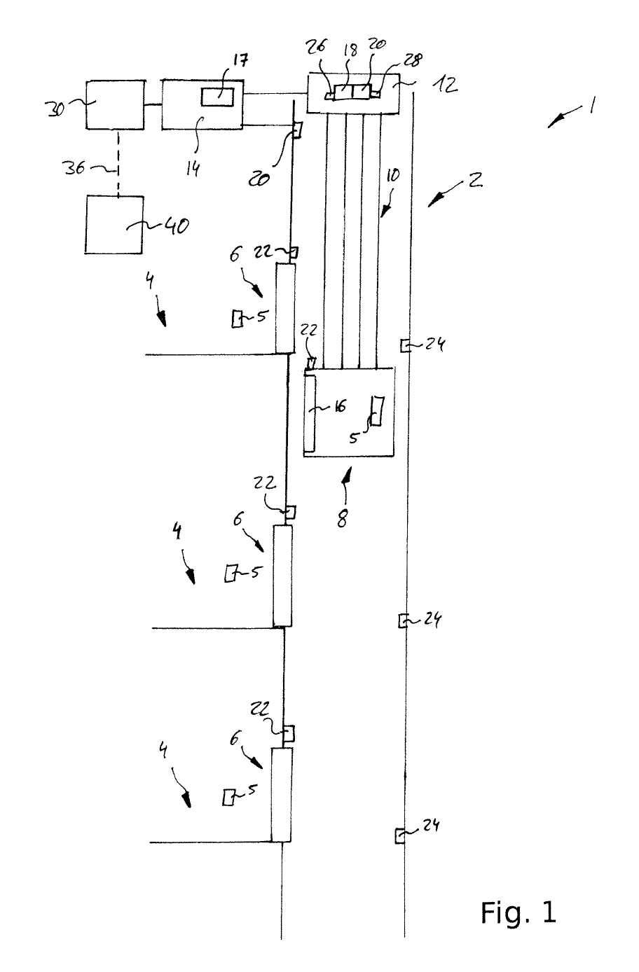

FIG. 1 shows a schematic illustration of an elevator 1 which is part of an elevator system according to an exemplary embodiment of the invention. The elevator 1 comprises a hoistway 2 extending between a plurality of floors 4. At least one hoistway door 6 is provided at each floor 4 allowing access to the hoistway 2 from the floor 4.

An elevator car 8 is suspended by means of at least one tension member 10 within the hoistway 2, the tension member 10 being connected to an elevator drive 12 provided at the top of the hoistway 2 allowing to move the elevator car 8 along the longitudinal extension of the hoistway 2 between the plurality of floors 4 by operating the elevator drive 12.

The elevator drive 12 comprises a motor 18 for moving the elevator car 8 and a brake 20 for preventing any movement of the elevator car 8 when it is located at one of the floors 4. The motor 18 and the brake 20 are provided with associated sensors 26, 28, which are configured for monitoring the operation of the motor 18 and the brake 20, respectively.

The elevator drive 12 may be located in any other portion of the hoistway, e.g. in a pit at the bottom of the hoistway or even mounted on the elevator car 8 itself. It also may be located in a separate machine room, which is not shown in FIG. 1. The elevator 1 may have or may not have a counterweight, which is not shown in FIG. 1.

The elevator car 8 comprises at least one elevator car door 16, which is located opposite to a corresponding hoistway door 6 when the elevator car 8 is positioned at a specific floor 4. The car door 16 and the corresponding hoistway door 6 open in coordination with each other in order to allow passengers to transfer between the elevator car 8 and the respective floor 4.

The elevator drive 12 is functionally connected to an elevator control unit 14 controlling the movement of the elevator car 8 and the opening and closing of the doors 6, 16.

A plurality of input units 5 are provided at each of the floors 4 and/or within the elevator car 8. The input units 5 are connected by wires (not shown) or by a wireless connection to the elevator control unit 14 in order to allow passengers to input control commands causing the elevator drive 12 to move the elevator car 8 to a desired floor 4.

In order to ensure a safe operation of the elevator 1, it is desirable to closely monitor the movement of the doors 6, 16, in particular to ensure that all doors 6, 16 are properly closed before the elevator car 8 is moved, in order to prevent passengers from falling into the hoistway and/or getting trapped between the floor 4 and the moving elevator car 8.

Thus, at least one door sensor 22, which is configured for monitoring the movement of the doors 6, 16, is provided at each of the doors 6, 16.

Additional positional sensors 24, which are configured for detecting of the elevator car 8 is correctly positioned at a specific floor 4, are provided in the hoistway 2.

The data collected by these sensors 22, 24, 26, 28 may be transferred via wires (e.g. wires of a travelling cable extending basically in parallel to the tension member 10), which are not shown in FIG. 1, or by a wireless connection to a receiver 20 connected to the elevator control unit 14.

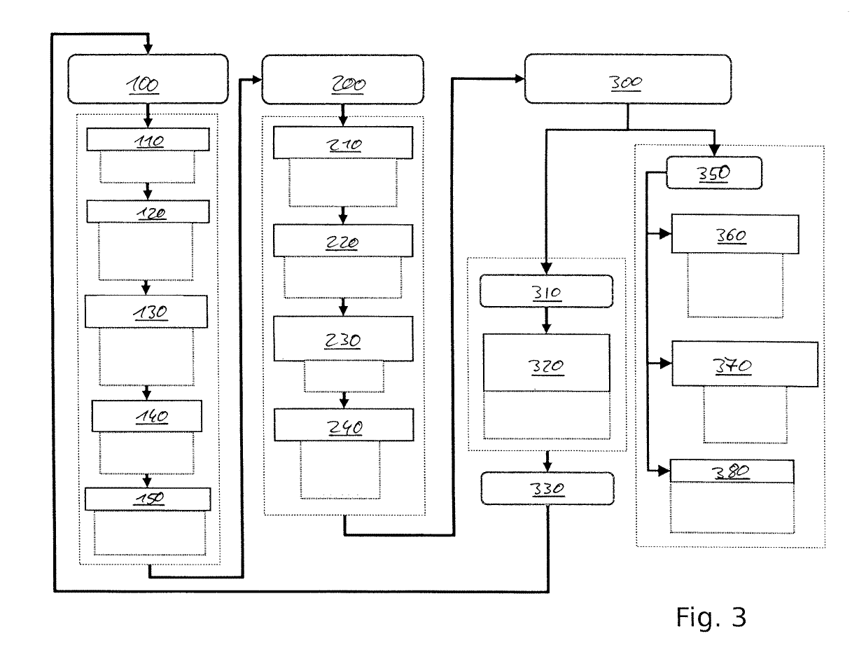

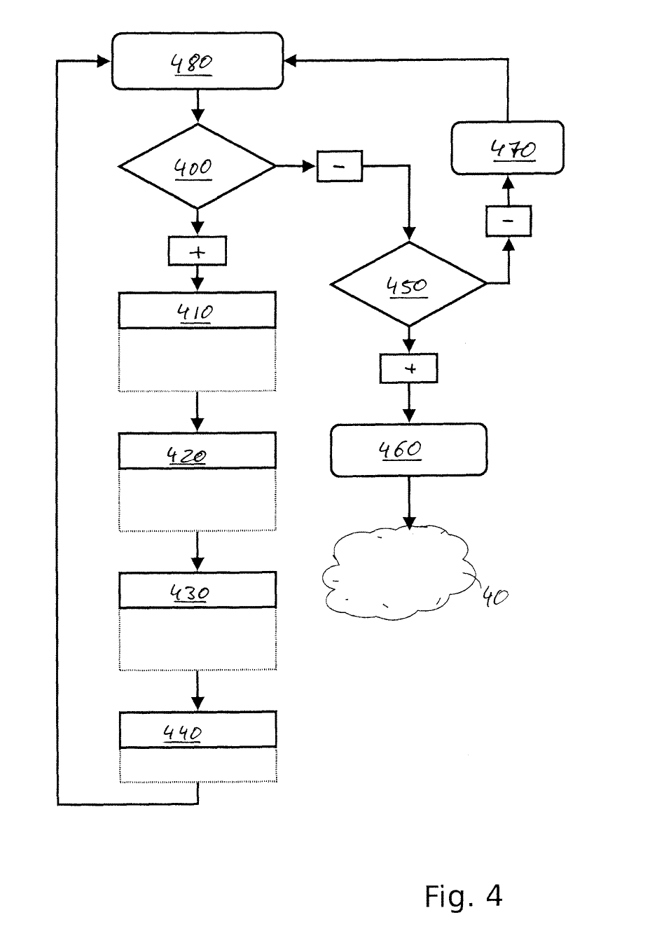

The elevator control unit 14 comprises a diagnostic unit 17, which is configured for monitoring the operation of the elevator 1 in order to detect any malfunction based on the data provided by the sensors 22, 24, 26, 28. The details of said monitoring will be described in the following with reference to FIGS. 3 and 4.

The elevator control unit 14 is further connected to a communication unit 30, which is configured to communicate via a data connection 36 with a remote diagnostic system 40, which also will be described in more detail further below.

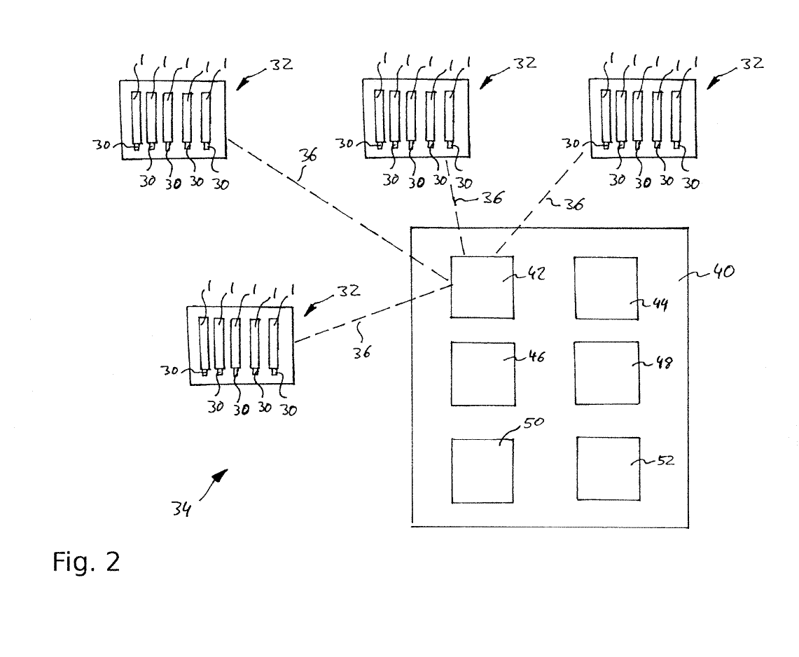

FIG. 2 shows an schematic view of an elevator system 34 according to an exemplary embodiment of the invention.

The elevator system 34 comprises a plurality of “smart” elevators 1, as they have been described before with reference to FIG. 1, located at a plurality of sites 32, such as buildings 32. Each site 32 may have one or more elevators 1.

Each of the elevators 1 is able to communicate by means of its respective communication unit 30 with a data receiving unit 42 of a diagnostic system 40, which may be implemented in the form of a “data cloud”, via a data connection 36, which may be implemented wired, wireless or as a combination of wired and wireless connections (e.g. via the internet).

The diagnostic system 40 comprises at least one storage unit (memory), 44 which is configured for storing elevator operation and diagnosis data and an analyzing unit 46, which is configured for automatically analyzing the elevator operation and diagnosis data received by the at least one receiving unit 42, in particular by comparing the received data with previously stored data, in order to detect any malfunction of one of the elevators 1.

The diagnostic system 40 further comprises an instruction unit 48, which is configured for sending instructions to be sent to the communication unit 30 of an elevator 1, for which a malfunction has been detected, instructing the respective elevator's 1 control unit 14 to perform at least one specific action based on the store information in order to overcome the detected malfunction.

Said instructions may include a shutdown and following restart of the elevator system, the deletion of failure detection flags and/or reset of the elevator control's 14 memory.

Additionally or alternatively, parameters of the elevator control may be changed, which will be discussed in detail further below.

The diagnostic system 40 further comprises a notification unit 50, which is configured for notifying a mechanic about a malfunction detected by the storing unit 46, and an order unit 52, which is configured for ordering spare parts which are necessary in order to overcome a detected malfunction.

FIG. 3 schematically illustrates the operation of a diagnostic system 40 according to an exemplary embodiment of the invention.

The operation basically comprises three kinds of steps, namely data collection and storage steps 100, data classification and evaluation steps 200, and action steps 300.

Data collection and storage is started with a step 110 for registering the elevator 1 with the diagnostic system 40, i.e. by transmitting data comprising the elevator's 1 individual unit number for unambiguously identifying the elevator 1 and an optional time stamp in order to keep record of the registering time.

In a second step 120 the elevator's status, as e.g. normal operation, inspection run, the elevator being blocked or disturbed, is evaluated and transmitted to the diagnostic system 40, where it is stored within the storage unit 44.

In order to reduce the amount of data to be transmitted, data may be sent only if the status changes, e.g. from normal operation blocked or disturbed. In addition, the amount of data may be reduced by sending only evaluated data, i.e. results instead of raw data.

In case failures or malfunctions have been identified by the elevator's 1 diagnostic unit 17, failure messages including the respective failure diagnosis are transmitted to and stored within the storage unit 44 as well (step 130). The detected failures may include a brake of the safety chain, the elevator drive 12 being shut down, the occurrence of an emergency stop or an interruption of the communication with the passengers within the elevator car 8 or broken communication between subsystems (e.g. operation to drive or to door system).

In a further step 140 parameters including self-adjusted parameters, as e.g. time out periods and actual limits, are transferred to the diagnosis unit 40, as well.

In the next step 150 the life time of components of the elevator 1, which are subjected to wear, as e.g. mechanical contacts, relays, switches, buttons of the input units 5 and sensors 22, 24, 26, 28 are transferred to the diagnostic system 40 and stored in the storage unit 44, too.

Thus, the data collection and storing steps 100 of the first group are characterized by data transmission from the respective elevator 1 to the diagnostic system 40.

A second group of steps 200 is related to the classification and evaluation of the data received by the diagnostic system 40.

First, the received data is classified according to the elevator's 1 sub-systems, as e.g. an operational control, a motion control and a door control of the elevator 1 (step 210).

In a second group of steps 220 failure messages which have been transmitted with respect to the respective sub-system are evaluated in order to identify the respective failure. These steps 220 may include checking the elevator's safety chain, the drive and/or communication lines extending between the elevator car 8 and a respective control center.

As a next step 230 spare parts, as e.g. brake switches or door locks, which may be needed for replacing corresponding defective parts of the elevator 1 in order to overcome the detected failure function, are identified.

In addition, spare parts for preventive maintenance, i.e. parts which do still work properly, but which are expected to reach the end of their expected lifetime shortly, are identified (step 240). The identified parts may be ordered in advance in order to be replaced at a mechanic's convenience before they actually result in a breakdown of the elevator 1.

A third group of steps 300 is related to how to react on the detected elevator status.

First, it is decided whether the detected problem can be overcome by the smart elevator himself (continue with step 310) by performing some predefined actions (step 320) as e.g. deleting failure flags, resetting the (failure) memory or even rebooting the whole elevator control system.

These actions are triggered by sending a message to the respective elevator 1 (step 330).

Alternatively, if it has been determined that the detected problem cannot be solved by the elevator 1 on its own, a mechanic is instructed to visit the elevator side (step 350) in order to check (step 360) the components causing the malfunction, replacing defective parts by appropriate spare parts (step 370) in order to overcome a malfunction or for preventive maintenance. Finally, the elevator information stored in the diagnostic system 40 is updated (step 380).

FIG. 4 schematically shows an example of a procedure for overcoming a blockade or malfunction of an elevator 1 by the elevator 1 itself by adjusting parameters of elevator's 1 operation. Such a procedure may be executed by the elevator 1 before sending data to the cloud (step 120 in FIG. 3), or as one of the predefined actions mentioned with respect to step 320 in FIG. 3.

In a first step 400, it is determined whether a failure has been detected.

In case a failure has been detected the failure messages received are collected in step 410 and the sub-system corresponding to the received failure messages is selected (step 420). Sub-systems inter alia may include operational control, motion control and door control of the elevator 1.

In a next step 430 a parameter of the selected sub-system is chosen, e.g. a timeout period, a current limit, a threshold etc. and the selected parameter is increased or decreased in step 440.

Next, in step 400 it is checked again, whether the malfunction is still present even with the changed parameter.

In case the malfunction is still present the procedure comprising steps 410, 420, 430 and 440, which have been described before, is repeated for adjusting the parameters of the elevator operation even further.

In case no malfunction is detected anymore, it is determined in step 450 whether at least one of the parameters has been changed in order to send in step 460 a notification about the changed parameters to the diagnostic system together with the information that the detected failure has been overcome by changing the respective parameter(s) accordingly.

This information may be used by the diagnostic system 40 in case a similar malfunction is detected by one of the other elevators 1 allowing to overcome the detected malfunction even faster by appropriately amending the corresponding parameter.

In case no failures are detected and no parameters have been changed, no further action is necessary (step 470) and the system will continue with normal operation (step 480).

A number of optional features are set out in the following. These features may be realized in particular embodiments, alone or in combination with any of the other features:

In an embodiment the diagnostic unit may be configured to periodically run the at least one diagnostic routine in order to detect malfunctions of the elevator fast and with high reliability.

In an embodiment the diagnostic system further may comprise a notification unit, which is configured for notifying a mechanic about a malfunction detected by the analyzing unit. This allows to send a mechanic to the elevator side without human intervention; in order to ensure that any problem of the elevator is fixed in short time without the need of humans being present at a service center in order to inform the mechanic that a problem has occurred.

In an embodiment the diagnostic system further may comprise an order unit, which is configured for ordering spare parts which are necessary in order to overcome a detected malfunction. This allows a fast ordering of parts which are needed for repairing the elevator; in particular, needed parts may be ordered even when no humans are available at the service center.

In an embodiment the analyzing unit further may be configured for detecting a need for preventive maintenance. This ensures an increased reliability of the elevators, as malfunctions may be avoided by replacing critical components before they break down causing a malfunction of the elevator.

In an embodiment each elevator may comprise a couple of subsystems and the diagnostic unit may be configured for monitoring each of said subsystems. This improves the quality of the monitoring and allows to detect malfunction of each of the subsystems fast and with high reliability.

In an embodiment each elevator may comprise a couple of subsystems and a couple of diagnostic units, wherein each of the diagnostic units is a specialized diagnostic unit which is configured for monitoring one of said subsystems. Specialized diagnostic unit are very effective in detecting malfunctions of their respectively associated subsystem. Providing a plurality of diagnostic units working independently of each other further enhances the reliability of the total system, as even in case of a breakdown or malfunction of one of the diagnostic units the other diagnostic units will continue to monitor the other subsystems.

In an embodiment the elevator system may comprise elevators which are located at different sites, e.g. in different buildings. This allows to effectively monitor a plurality of elevators, which are spread over a plurality of sites, which may be located in different cities, countries, or even on different continents as long as a reliable data connection can be provided.

In an embodiment the communication unit may be configured to transmit the data over a telephone network or a digital data network including wired networks and wireless networks. Using existing networks, as e.g. the telephone network or the internet, for data transmission allows an easy and cheap implementation of the system. As usually no big amounts of data need to be transferred, telephone lines may be used for the data transfer. This allows implementing and using the system even in areas in which no (fast) data connections are available.

In an embodiment automatically analyzing the elevator operation and diagnosis data may include comparing the received data with previously stored data, which allows analyzing the data fast and effectively.

In an embodiment the instructions sent to the elevator may include instructions for changing operational parameters of the elevator, to delete failure detection flags, to reset a memory and/or to switch off and restart the elevator. Changing operational parameters, as e.g. time out periods, time limits, velocities of the doors and/or the elevator car, may provide a very effective and easy way to overcome a malfunction. Resetting the memory and/or switching off and restarting the elevator may help in case a singular event has caused some disorder in memory resulting in improper operation of the elevator.

In an embodiment the method may include automatically ordering at least one spare part which is needed in order to overcome a detected malfunction. This allows a fast repair of the elevator, as the spare part will be delivered fast and without a need for human intervention.

In an embodiment the method may include monitoring the number of activations of elevator components in order to detect the need for preventive maintenance when the number of activations of an elevator component exceeds a predetermined limit. This ensures an increased reliability of the elevators, as malfunctions may be avoided by replacing critical components after a predetermined number of activations before they break down and cause a malfunction of the elevator.

### REFERENCES

1 elevator

2 hoistway

4 floor

5 input unit

6 hoistway door

8 elevator car

10 tension member

12 elevator drive

14 elevator control unit

16 car door

17 diagnostic unit

18 motor

20 brake

22 door sensor

24 positional sensors

26 motor sensor

28 brake sensor

30 communication unit

32 site

34 elevator system

36 data connection

40 remote diagnostic system

42 data receiving unit

44 storage unit

46 analyzing unit

48 instruction unit

50 notification unit

52 order unit

100 storage steps

110 registration step

120 status evaluation and transmission step

130 failure message transmission and storage step

140 parameter adjusting step

150 lifetime transferring step

200 data classification and evaluation steps

210 received data classification step

220 failure message evaluation step

230 spare parts ordering step

240 spare parts identification and ordering step

300 action steps

310 solving the problem by the smart elevator

320 actions performed by the smart elevator

330 sending a message to the respective elevator

350 instructing a mechanic

360 checking components

370 replacing defective parts

380 updating the diagnostic system

400 determining whether a failure has been detected

410 collecting received failure messages

420 selecting a sub-system

430 choosing a parameter of the selected sub-system

440 changing the selected parameter

450 determining whether at least one parameter has been changed

460 sending a notification about changed parameters

470 no further action

480 normal operation

1. Elevator system (34) comprising:
A) a plurality of elevators (1) each of the elevators (1) comprising:
Aa) a diagnostic unit (17), which is configured for running at least one diagnostic routine checking components of the elevator (1) and providing elevator operation and diagnosis data;
Ab) a communication unit (30), which is configured
i) for transmitting the elevator operation and diagnosis data provided by the diagnostic unit (17) to a remote diagnostic system (40); and
ii) for receiving control commands from said remote diagnostic system (40); and
Ac) a control unit (14), which is configured for executing the control commands received by the communication unit (30);
B) a remote diagnostic system in the cloud (40) comprising:
Ba) at least one data receiving unit (42), which is configured for receiving the elevator operation and diagnosis data transmitted from the communication unit (30);
Bb) at least one storage unit (44), which is configured for storing elevator operation and diagnosis data;
Bc) at least one analyzing unit (46), which is configured for automatically analyzing the elevator operation and diagnosis data received by the at least one receiving unit (42) in order to detect a malfunction of an elevator (1); and
Bd) at least one instruction unit (48), which is configured for sending instructions to the communication unit (30) of an elevator (1), for which a malfunction has been detected, instructing the control unit (14) of said elevator (1) to perform at least one specific action in order to overcome a detected malfunction.

2. Elevator system (34) of claim 1, wherein the diagnostic unit (17) is configured to periodically run the at least one diagnostic routine.

3. Elevator system (34) of claim 1, wherein the diagnostic system (40) further comprises a notification unit (50), which is configured for automatically notifying a mechanic about a malfunction detected by the storing unit (46).

4. Elevator system (34) of claim 1, wherein the diagnostic system (40) further comprises an order unit (52), which is configured for automatically ordering spare parts which have been identified as being necessary for overcoming a detected malfunction.

5. Elevator system (34) of claim 1, wherein the storing unit (46) is further configured to detect a need for preventive maintenance.

6. Elevator system (34) of claim 5, wherein the storing unit (46) is configured to detect a need for preventive maintenance based on the number of activations of selected components (5, 20, 22, 24, 26, 28) of the elevator (1).

7. Elevator system (34) of claim 1, wherein each elevator (1) comprises a couple of subsystems and the diagnostic unit (17) is configured to monitor each of said subsystems.

8. Elevator system (34) of claim 1, wherein each elevator (1) comprises a couple of subsystems and a couple of diagnostic units (17), wherein each of the diagnostic units (17) is configured to monitor one of said subsystems.

9. Elevator system (34) of claim 1, wherein the elevator system (34) comprises elevators (1) which are located at different sites (32).

10. Elevator system (34) of claim 1, wherein the communication unit (30) is configured to transmit the data over a telephone network or a digital data network including wired networks and wireless networks and combinations thereof.

11. Method of monitoring a system comprising a plurality of elevators (1), wherein the method includes the steps:
a) running at least one diagnostic routine on an individual elevator (1) for checking components of the elevator (1) and providing elevator operation and diagnosis data;
b) transmitting the elevator operation and diagnosis data provided by the diagnostic unit (17) to a remote diagnostic system (40);
c) storing elevator operation and diagnosis data;
d) automatically analyzing the elevator operation and diagnosis data for detecting a malfunction of the individual elevator (1);
e) sending instructions to said individual elevator (1), for which a malfunction has been detected, instructing said elevator (1) to perform a specific action in order to overcome a detected malfunction and/or sending informing about a detected malfunction to a mechanic.

12. Method of claim 11, wherein the step of automatically analyzing the elevator operation and diagnosis data includes comparing the received data with previously stored data.

13. Method of claim 11, wherein the instructions sent to the elevator (1) include instructions (140) to change operational parameters of the elevator (1), to delete failure detection flags, to reset a memory and/or to switch off and restart the elevator (1).

14. Method of claim 11 further including the step (230) of ordering at least one spare part which is needed in order to overcome a detected malfunction.

15. Method of claim 11 further including the step of monitoring the number of activations of elevator components in order to detect the need for preventive maintenance when the number of activations of an elevator component exceeds a predetermined limit.
